(19) United States
(12) Patent Application Publication
(10) Pub. No.: US 2025/0284442 A1
(43) Pub. Date: Sep. 11, 2025

(54) INDUSTRIAL PRINTING SYSTEM, PRINT SERVER, AND PROCESSING MANAGEMENT METHOD FOR SETTING PROHIBITION IN PEER-TO-PEER PRODUCTION PRINTING

(71) Applicant: KYOCERA Document Solutions Inc., Osaka (JP)

(72) Inventor: Taku MATSUO, Los Angeles, CA (US)

(73) Assignee: KYOCERA Document Solutions Inc., Osaka (JP)

(21) Appl. No.: 18/597,290

(22) Filed: Mar. 6, 2024

(51) Int. Cl. G06F 3/12

(52) U.S. Cl. CPC G06F 3/1239; G06F 3/1204; G06F 3/1267; G06F 3/1282; G06F 3/1288

(57) ABSTRACT

Provided is an industrial printing system that can improve security while performing peer-to-peer distributed processing in production printing. The industrial printing system performs production printing. A plurality of print servers that perform distributed processing of jobs is provided. Each of the plurality of print servers provides a prohibition management unit and a processing management unit. The prohibition management unit generates a prohibition setting that restrict printing and processing on a distributed print server for each job setting. The processing management unit sends the job associated with the prohibition settings generated by the prohibition management unit to the other print server for processing.

### BACKGROUND

The present disclosure relates to an industrial printing system, a print server, and a processing management method that perform distributed processing, especially for industrial printing (production printing).

In a typical print system that includes a plurality of printers, there is a print system that performs so-called ubiquitous printing. In this system, when a print system that includes a plurality of printers (MFPs) receives a ubiquitous job from a PC that has issued the ubiquitous job, the first MFP stores the print settings in its memory if they can be processed by its own print function, and if not, it forwards the job to the next MFP. This process is performed in a predefined order from the first MFP to the Nth MFP. This saves the ubiquitous job in the memory of the MFPs that can process it. As a result, the waiting time for the user to obtain a printed document can be reduced in the printing system.

In other words, in this typical technique, print data (jobs) are transferred to each MFP as they are, and the transferred MFP itself determines whether or not it is capable of processing them.

On the other hand, in industrial printing, known as production printing, which uses commercial (industrial) printing equipment, the components of the final product are produced by dividing the work among a plurality of processes. For example, in the case of bookbinding, the cover, body (color), body (black and white), promotional materials, belt, and shipping envelope are processed as different jobs. The jobs are then combined in intermediate processes to produce the final product, the book.

### SUMMARY

An industrial printing system is an industrial printing system for performing production printing having a plurality of print servers for distributed processing of a job, each of the plurality of print servers including: a prohibition management unit that generates a prohibition setting that restrict printing and processing on other print server in distributed destination for each job setting; a processing management unit that sends the job associated with the prohibition setting generated by the prohibition management unit to the other print server and requests processing.

A print server of the present disclosure is a print server that performs distributed processing of a job in an industrial printing system that performs production printing, including: a prohibition management unit that generates a prohibition setting that restrict printing and processing on other print server in distributed destination for each job setting; and a processing management unit that sends the job associated with the prohibition setting generated by the prohibition management unit to the other print server and requests processing.

A processing management method of the present disclosure is a processing management method executed by an industrial printing system having a plurality of print servers that perform distributed processing of a job and performs production printing, including the steps of: generating a prohibition setting that restrict printing and processing on other print server in distributed destination for each job setting; and sending the job associated with the prohibition setting that is generated to the other print server to request processing.

### BRIEF DESCRIPTION OF THE DRAWINGS

FIG. 1 is an example of a system configuration diagram of an industrial printing system according to an embodiment of the present disclosure;

FIG. 2 is a block diagram showing a control structure of the print server as shown in FIG. 1;

FIG. 3 is a block diagram describing a functional structure of the print server as shown in FIG. 1;

FIG. 4 is a block diagram showing details of the prohibition setting as shown in FIG. 3;

FIG. 5 is a conceptual diagram describing a print processing area of the storage unit as shown in FIG. 3;

FIG. 6 is a flowchart of distributed prohibition printing process according to an embodiment of the present disclosure; and

FIG. 7 is a conceptual diagram of the prohibition setting and the job processing request in the distributed prohibition printing process as shown in FIG. 4.

### DETAILED DESCRIPTION

### Embodiment

### (Configuration of Industrial Printing System X)

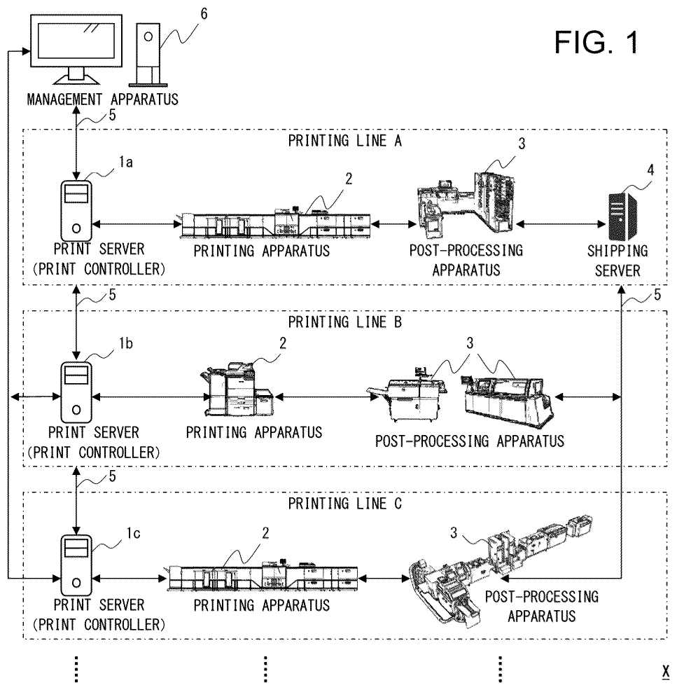

Firstly, with reference to FIG. 1, an example of the overall system configuration of an industrial printing system X is described.

The industrial printing system X is a system that executes output by printing process and post-processing process (hereinafter simply referred to as “printing”) in industrial printing (production printing).

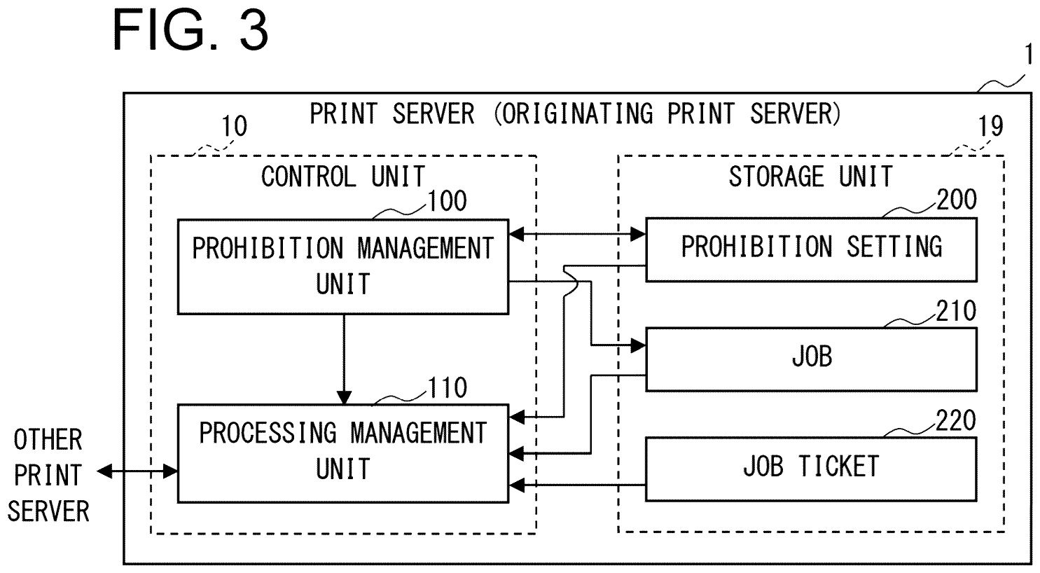

Here, in the industrial printing system X according to the present embodiment, the final product, such as a book to be output, and the like, is referred to as an “order,” and each component of the order is referred to as a job 210 (FIG. 3).

In the industrial printing system X, sites (printing lines) of printing companies and printing factories, or the like, are connected and coordinated with a network 5. Each site includes a print server 1 and printing-related apparatuses such as a printing apparatus 2 and a post-processing apparatus 3, and shipping server 4, or the like (hereinafter referred to as “component apparatuses”).

In FIG. 1, an example of the coordination between the sites is shown in which the print servers 1a, 1b, 1c, . . . on the printing lines A, B, C, . . . and the shipping server 4 on the printing line A are connected with the network 5. Furthermore, in this example, the component apparatuses, which are the printing apparatuses 2a, 2b, 2c, . . . , and the post-processing apparatuses 3a, 3b, 3c, . . . , are connected with the print servers 1a, 1b, 1c, . . . in printing lines A, B, C, . . . , respectively.

Hereafter, when any one of these print servers 1a, 1b, 1c, . . . is indicated, it is simply referred to as a print server 1. Similarly, when any one of these print servers 2a, 2b, 2c, . . . is indicated, it is simply referred to as a print server 2. Similarly, when any one of post-processing apparatuses 3a, 3b, 3c, . . . is indicated, it is simply referred to as a post-processing apparatus 3.

The print server 1 is an example of an information processing apparatus, such as a digital front end (DFE), print controller, or the like, which manages and controls component apparatuses. The print server 1 may be configured with a PC (Personal Computer) server, a dedicated machine, a general-purpose machine, or the like.

In the present embodiment, the print server 1 executes a dedicated print management application software (hereinafter simply referred to as an “application”), and peer-to-peer distributed processing of the job 210 (FIG. 3) for production printing is performed.

This print management application (hereinafter referred to as a “dedicated application”) may be executed on a common platform that performs print design creation, user management, tenant management, security management, maintenance notification service, prepress processing management, storage management of each document, management of the printing apparatus 2, or the like.

Specifically, in production printing, the print server 1 sends and receives various instructions and information to and from the printing apparatus 2, the post-processing apparatus 3, and the shipping server 4, or the like. In this way, the print server 1 manages the status of each apparatus and requests the processing of the job 210.

In the present embodiment, a print server 1 that is a processing request side (a source of distributed processing) is hereinafter referred to as the “originating print server.” On the other hand, a print server 1 that is a requested processing side (a destination of distributed processing) is hereinafter referred to as the “other print server.” In the present embodiment, the scheduling of at least some of the jobs 210 and the prohibition processing as described later are performed between the originating print server and the other print server. Moreover, the originating print server or the other print server assigns the processing of the job 210 to each component apparatus in its site and makes it execute the processing according to the schedule.

The printing apparatus 2 includes industrial printers, including image forming apparatus for small-lot printing, and automated printing apparatus 2 that performs offset printing and other processes for large-volume (a plurality of-lot) printing.

The printing apparatus 2 at each location according to the present application may differ in the size, paper quality, color profile, recordable range, or the like of the recording paper used in printing.

The post-processing apparatus 3 is a post-processing apparatus for performing post-processing such as folding, collating, bookbinding, cutting, bookbinding, and the like, of recording paper printed by the printing apparatus 2.

The post-processing apparatus 3 at each site in the present embodiment may also differ in content, range, or the like, of processing that can be executed in post-processing.

The shipping server 4 is a server that manages the shipping of orders sent from each site after printing or post-processing has been completed.

In the present embodiment, an example by using the shipping server 4 at a site of company A is described, the other sites may also be provided with the shipping servers 4.

The network 5 may be a LAN (Local Area Network), wireless LAN (Wi-Fi), WAN (Wide Area Network), cellular phone network, industrial network, other dedicated lines, voice telephone network, USB (Universal Serial Bus), RS-232C, or the like. The network 5 can send and receive various commands and data to and from each apparatus. Furthermore, the print server 1 and each component apparatus may also be connected to each other by LAN, or the like, in the network 5. In addition, the network 5 may be set up as a VPN (Virtual Private Network), or the like.

**The management apparatus 6 is an administrator terminal such as a PC, smartphone, tablet terminal, PDA (Personal Data Assistant), or the like, used by a user who includes an administrator, from inside and outside each site. The management apparatus 6 manages a processing request for each apparatus in the image forming system X. This allows each the print server 1 to be accessed by the user by using a web browser, a terminal software, dedicated application, or the like, to manage the prohibition setting 200 and the job 210 (FIG. 3). Specifically, the management apparatus 6 may use the dedicated application described above to create the job 210, manage distribution, and manage the prohibition settings 200 and their historical information, or the like. Furthermore, the management apparatus 6 may also be capable of executing prepress applications that control prepress for production printing, design applications, or the like. Furthermore, the management apparatus 6 may be connected with another terminal for submitting a manuscript, a terminal for design proofreading, and the like.

Additionally, a general terminal used by the user may be connected via the network 5 from inside and outside each site. This makes it possible to obtain the job 210, design of printing, submit, manage prepress processing, check progress, and request processing, or the like.

Note that a plurality of these apparatuses may exist depending on the purpose, scale of printing, and the like. Each apparatus can be connected to the print server 1 via the network 5 and LAN, or the like, by various protocols. Alternatively, the print server 1 and each apparatus may be directly wired to each other by using various interfaces such as USB, RS-232C, or the like.

In addition, each location may be provided with other component apparatuses managed by the print server 1. The other component apparatuses include, for example, a terminal for submitting manuscripts, a terminal for design proofreading, a prepress apparatus, and the like.

### (Control Configuration of the Print Server 1)

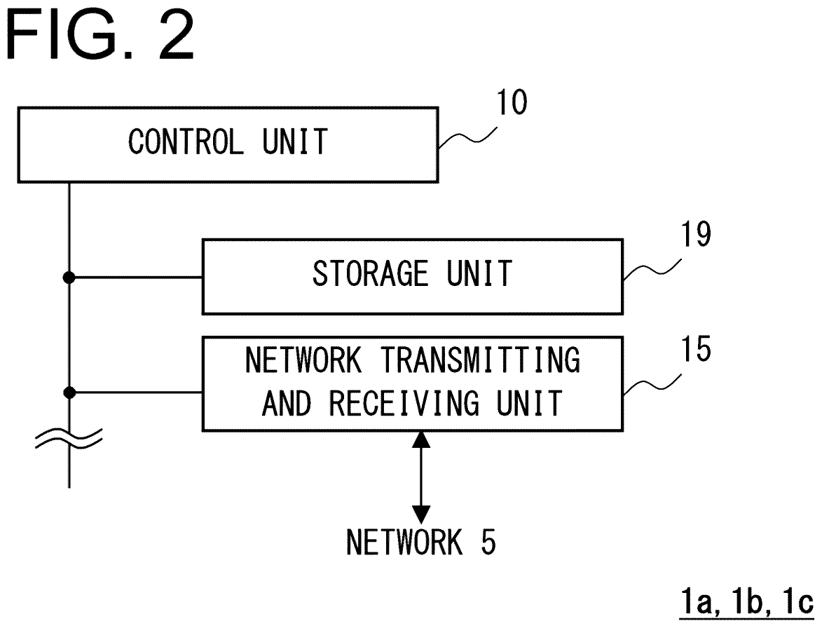

Next, with reference to FIG. 2, a control configuration of the print server 1 is described.

The print server 1 includes a control unit 10, a network transmitting and receiving unit 15, a storage unit 19, and the like. Each unit is connected with the control unit 10 and its operation is controlled by the control unit 10.

The control unit 10 is an information processing unit such as GPP (General Purpose Processor), CPU (Central Processing Unit, central processing unit), MPU (Micro Processing Unit), DSP (Digital Signal Processor), GPU (Graphics Processing Unit), ASIC (Application Specific Integrated Circuit, application specific processor), or the like.

The control unit 10 is made to operate as each of the functional blocks as described later by reading the control program stored in the ROM or HDD of the storage unit 19, expanding the control program into RAM, and executing it. The control unit 10 also controls the entire apparatus according to the instruction information input from the management apparatus 6 or a console.

The network transmitting and receiving unit 15 is a network connection unit that includes a LAN board, a wireless transmitting and receiving device, or the like, for connection to the network 5.

The network transmitting and receiving unit 15 transmits and receives data on a data communication line and voice signals on a voice telephone line.

The storage unit 19 is a non-temporary storage medium including a semiconductor memory such as ROM (Read Only Memory) or RAM (Random Access Memory), an HDD (Hard Disk Drive), or the like.

The ROM and HDD of storage unit 19 store a control program for controlling the operation of the print server 1. The control program includes the operating system (OS), middleware on the OS, services (daemons), various applications, database data, and the like. Among these, the various applications include the dedicated applications as described above.

In the present embodiment, the storage unit 19 stores a program and data for processing a raster-in-process (hereinafter abbreviated as “rasterize” or “RIP”) that converts vector (line drawing) image data into image data for printing (raster data). The programs and data for this rasterization process also include a commercial library, a font, or the like. In addition, the storage unit 19 also stores information, control programs, or the like for component apparatuses connected to the same printing line.

Further, the storage unit 19 may also store an account setting, other data, or the like for users including the administrator of the industrial printing system X.

In the present embodiment, as described later, the storage unit 19 may be able to manage the storage area so as to divide and isolate into a plurality of areas.

In the print server 1, the control unit 10 may be integrally formed, such as a CPU with a built-in GPU, a chip-on-module package, a SOC (System On a Chip), or the like.

The control unit 10 may also have built-in RAM, ROM, flash memory, or the like.

### (Functional Configuration of Print Server 1)

Here, with referring now to FIG. 3, a functional configuration of the print server 1 is described.

The control unit 10 of the print server 1 has a prohibition management unit 100 and a processing management unit 110.

The storage unit 19 stores a prohibition setting 200, a job 210, and a job ticket 220.

The prohibition management unit 100 generates the prohibition setting 200 for each of the job setting 210.

For example, the prohibition management unit 100 can set the prohibition setting 200 to prevent mixing with other job 210.

The prohibition management unit 100 can also add and/or change the prohibition setting 200 according to the content of the job 210.

The processing management unit 110 sends the job 210, which is associated with the prohibition setting 200 generated by the prohibition management unit 100, to the other print server to request processing with the job ticket 220. In this case, the processing management unit 110 may encrypt the job 210 and send it.

Here, a processing management unit 110 of the other print server that is requested to process the job 210 can also store the job 210 requested to be processed in a print processing area 190 in the storage unit 19. The print processing area 190 is an isolated area within the storage unit 19 that is different from that for the normal job 210. Details of this isolation are explained later.

Further, the processing management unit 110 can send and receive processing status and a completion notification of the job 210 between the print servers 1. Thus, the processing management unit 110 can manage the processing of the job 210.

The prohibition setting 200 is configuration data for restricting printing and processing on the print server 1 at a destination of distributed processing.

The details of the prohibition setting 200 are described later.

The job 210 is a production print job, which is a collection of various data used in printing. The job 210 may be described, for example, in JDF (Job Description Format) and/or JMF (Job Messaging Format).

The details of Job 210 are also described later.

The job ticket 220 is configuration data that includes print instruction attributes for requesting the job 210. In the present embodiment, the job ticket 220 includes settings so as to use the prohibition setting 200 in addition to the execution instructions for the job 210. Further, the job ticket 220 may include a lower-level setting in the workflow, which is an order setting, as a print instruction attribute. The lower-level setting may be a setting necessary for printing step and post-processing step, and it may be color profile designation, imposition designation, paper designation, bookbinding designation, and the like.

The job ticket 220 may also be described in JDF and/or JMF.

### (Details of Prohibition Setting 200)

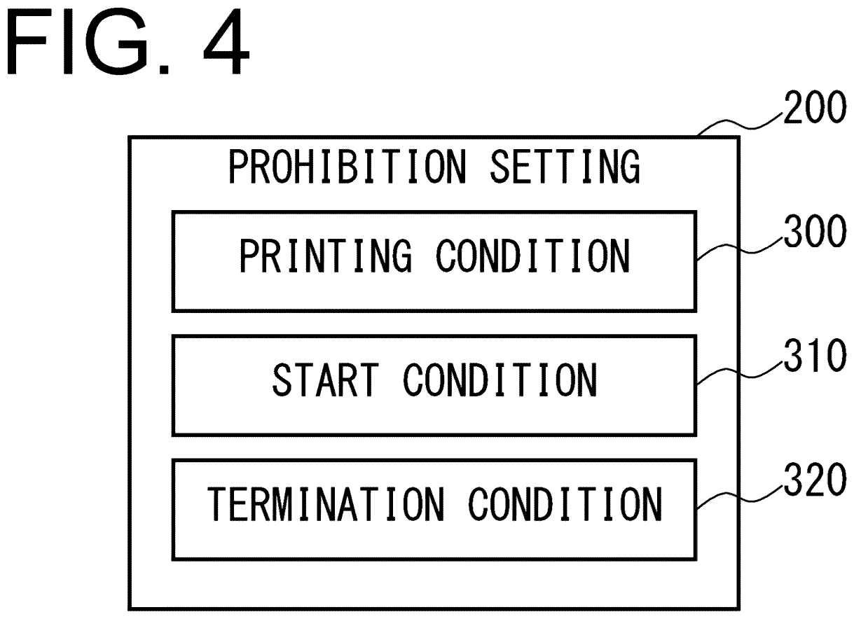

Next, as refer to FIG. 4, details of the prohibition setting 200 are explained.

The prohibition setting 200 can be set printing condition 300, start condition 310, and termination condition 320.

The printing condition 300 is configuration information that indicates the conditions for printing the job 210. The printing condition 300 includes a setting to restrict print attributes that is allowed to be specified by the user. Specifically, the printing condition 300 may be a setting that restricts the print attributes at the other print server in the distributed destination according to the distributed job 210. This setting of restrictions in the printing condition 300 allows the user to operate only in accordance with the restrictions on the UI (User Interface) when accessing the other print server from the management apparatus 6 or another terminal. Also, the print attribute that can be specified on the UI by the user is restricted.

The start condition 310 is configuration information that indicates the condition for starting the processing of the job 210. Specifically, the start condition 310 may be a setting to start print processing after the other job is deleted. For example, as the start condition 310, a condition can be set to check whether a file or data of the other job do not exist in the print processing area 190 or the other area in the storage unit 19.

Further, the start condition 310 may include a condition for the removal of printed matter from the discharge destination. Specifically, the start condition 310 may be a setting to start the print process after the other printed matters have been removed from the discharge destination.

The termination condition 320 is setting information that indicates the condition for the termination of the processing of the job 210. Specifically, the termination condition 320 may be a setting for completing the print process after the job 210 has been removed. For example, the termination condition 320 can be set a condition to confirm that the job 210 has been deleted from the storage unit 19.

Further, the termination condition 320 may also be a condition for removal of the printed matter from the discharge destination. Specifically, the termination condition 320 may be a setting that completes the print process after the printed matter of the output job 210 has been removed from the discharge destination.

The prohibition setting 200 may be initially set for each print server 1 for each printing line or for each type of the job 210. For example, for each printing line, an initial setting may be set according to the capabilities of the print server 1 and each component apparatus, discharge conditions, and the other geographical conditions. Further, in the case of a job 210 having personal information with secure priority, or the like, an initial setting with a stricter condition may be set. Conversely, in the case of a job 210 with low security, a less restrictive and less stringent initial setting of condition may be set.

### (Details of Job 210)

Then, the details of the job 210 in the present embodiment are described.

The job 210 may include, for example, a job information, print data, print resources, or the like.

The job information is data that includes an attribute specified in the printing process (hereinafter referred to as “specified attribute”). In the job information, as the specified attribute, type of job 210, name of job 210, name of project (order), designation of printing apparatus 2 or post-processing apparatus 3, number of copies, collation or not, recording or not, mm for cutting, printing direction, printing status, priority number, or the like. Among these, the type of the job 210 include a job in the printing process (a printing job) and a job in the post-processing process (a post-processing job).

The print data is the data of a printed manuscript, where design is set according to the order. The print data may be, for example, electronic document data such as PDF (Portable Document Format), PS (PostScript) data, other vector data, data in a format for submission, the other raster image data, or the like.

The printing resources are information on various resources required for printing instructions, such as a color profile, a spot color, a font, or the like. These various resources correspond to the prohibition setting 200.

Other resource data necessary for printing are also included in this printing resource.

In addition, the job 210 may have rasterized image data based on the job ticket 220. This image data may be, for example, TIFF or other bitmap data. Additionally, the image data may be lossless or irreversibly compressed.

### (Details of Print Processing Area 190)

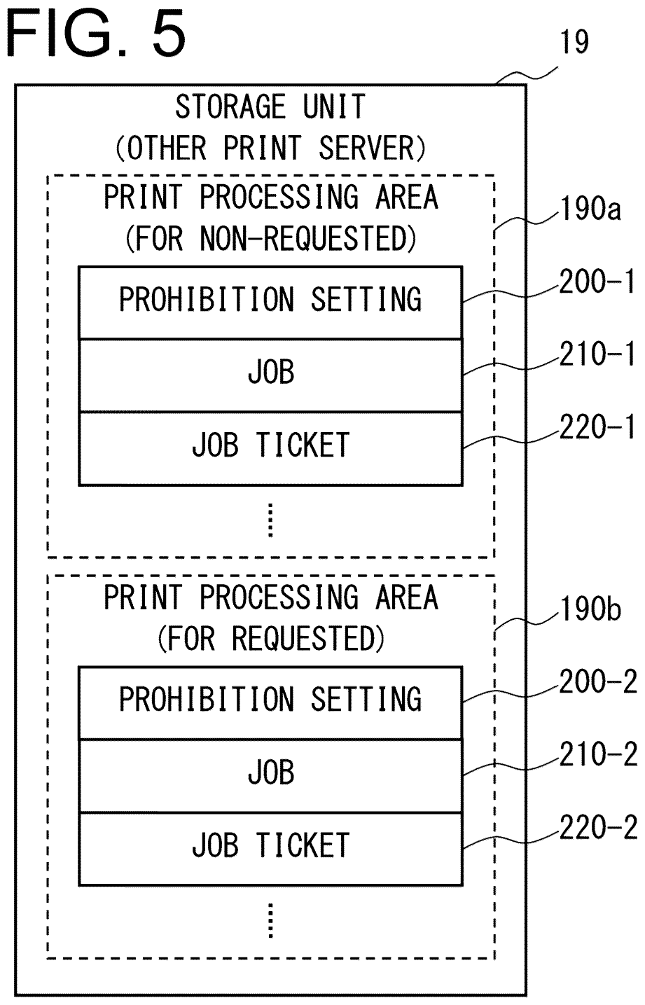

As refer to FIG. 5, a configuration of the storage unit 19 is described when the print server 1 is to be the other print server on the side where the processing is requested.

In this case, a plurality of print processing areas 190 can be set up in storage unit 19. Further, the print processing area 190, which is the data spooling area for the distributed job 210, is isolated.

In the example in FIG. 5, the storage unit 19 includes a print processing area 190a for a job 210, which is unrequested and self-use, and a print processing area 190b for a job 210, which distributed processing has been requested. That is, the print processing area 190a is a normal spool area, and the print processing area 190b is an isolated area (isolated print processing area).

In this example, the print processing area 190a stores the prohibition setting 200-1, the job 210-1, and the job ticket 220-1 for a non-requested job.

On the other hand, the print processing area 190b stores the prohibition setting 200-2, the job 210-2, and the job ticket 220-2 for the job requested by the dispersing origin. At this time, when each of the job 210 is processed for printing, such as RIP processing, or the like, temporary data and other data may also be stored and isolated in the same print processing area 190b.

In addition to this, the storage unit 19 may also include historical information indicating whether or not the process has been performed by using the prohibition setting 200, the result of the process, and the like. The historical information may be sent and accumulated to the originating print server from the other print server.

Further, the storage unit 19 may store schedule information indicating the status of the schedule for the execution of each job 210. The schedule information is set, for example, the schedule of available, tentative reservation, reserved (busy), or the like, at each of the time periods for the printing process and post-processing process. Furthermore, when the job 210 is tentative or reserved in the schedule, the ID, type, component apparatus to be used, status, or the like of job 210 are set as the contents of the job 210. Among these, the status of the job 210 includes the job to be processed and the progress (delay) status of the previous job. In addition, the schedule information may also reflect the operating status of each component apparatus, or the like.

Here, the control unit 10 of the print server 1 is made to function as the prohibition management unit 100 and the processing management unit 110 by executing the control program stored in the storage unit 19.

Each unit of the print server 1 described above is a hardware resource that executes the processing management method according to the present disclosure.

Some or any combination of the above functional configurations may be configured in hardware or circuitry by using ICs, programmable logic, FPGA (Field-Programmable Gate Array), or the like.

### (Distributed Prohibition Printing Process by Print Server 1)

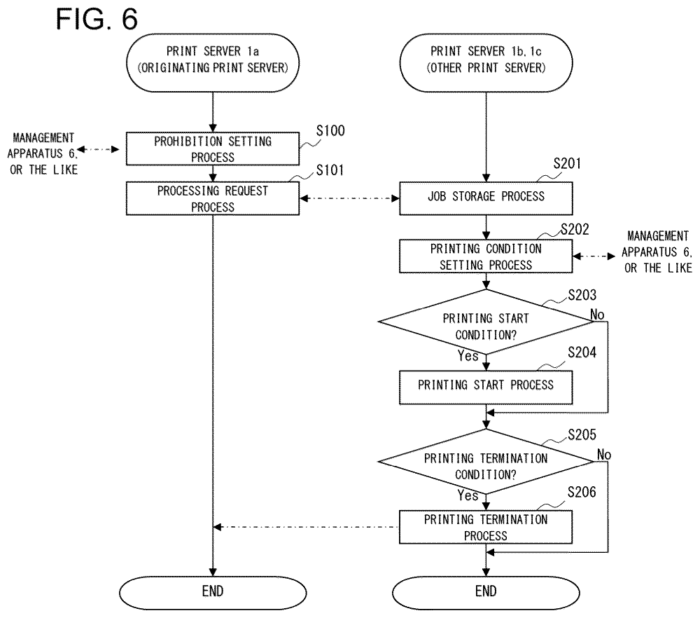

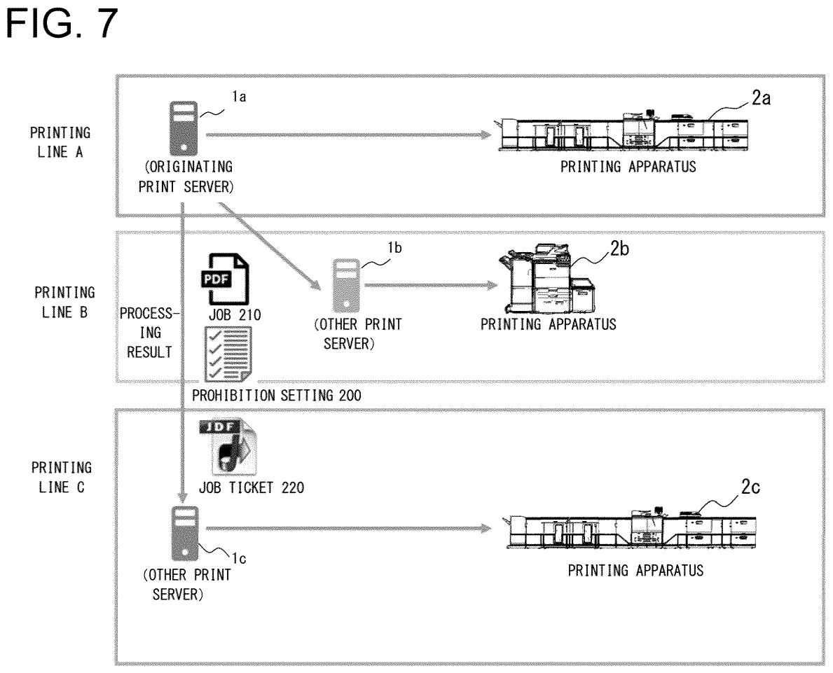

Next, as refer to FIGS. 6 to 7, a distributed prohibition printing process by the print server 1 according to the present disclosure is explained.

In the present embodiment of the distributed prohibition printing process, for each job 210 setting, the prohibition setting 200 that restricts printing and processing on the other print server at the distributed destination is generated. Then, the job 210, which are associated with the generated prohibition settings 200, and the prohibition settings 200 itself are sent together with the job ticket 220 to the other print server to request processing.

In the distributed prohibition printing process according to the present embodiment, as a representative example, the print server 1a on printing line A (site) is the originating print server (the side that requests the processing, the processing request source), and print servers 1b and 1c on printing lines B and C (sites) are the other print servers (the side that the process is requested, destination of distributed processing). On this basis, the main control unit 10 of these print servers 1a, 1b, 1c executes the program stored in the storage unit 19 in cooperation with each unit and using hardware resources.

In the following, with reference to the flowchart in FIG. 6, the details of the distributed prohibition printing process are explained step by step.

### (Step S100)

Firstly, the prohibition management unit 100 of the print server 1a performs a prohibition setting process.

The prohibition management unit 100 generates prohibition setting 200 that restrict printing and processing on the other print server at the distributed destination for each job setting 210.

Specifically, the prohibition management unit 100 acquires a job 210 to be subjected to peer-to-peer distributed processing from an inter-site management system that is in upstream of the industrial printing system X, the management apparatus 6, the prepress apparatuses, or the like. The job 210 may be created for the manuscript submitted by the submission terminal. At this time, the prohibition management unit 100 may cause the management apparatus 6 to execute the web browser or the dedicated application and allow the user to create the job 210. The user can give instructions from a GUI (Graphical User Interface) on the screen of the web browser or the dedicated application.

In the example according to the present embodiment, the prohibition management unit 100 may automatically generate the job ticket 220 for the created job 210 that includes the settings for each page.

Further, in the present embodiment, for each of the job 210, the prohibition management unit 100 may acquire user instructions by the management unit 6 to generate the prohibition setting 200. This user instruction may also be obtainable by using the GUI on the dedicated application.

Furthermore, the prohibition management unit 100 may automatically generate the prohibition setting 200 when generating the job 210 or the job ticket 220. In such case, the prohibition management unit 100 may analyze the content of the job 210 and set it in the prohibition settings 200.

Furthermore, the prohibition management unit 100 can also generate the prohibition setting 200 based on the initial setting of the prohibition setting 200 stored in the storage unit 19. In such case, the prohibition management unit 100 may generate the prohibition setting 200 according to the type of the job 210 and the print line belonging to the other print server to be requested.

The prohibition management unit 100 can, for example, be set to restrict the functions and attributes that can be performed in the printing condition 300. Furthermore, for example, the prohibition management unit 100 can set restrictions on deletion or removal in the start condition 310 or the termination condition 320.

In addition, the generated prohibition setting 200 may be sent from the originating print server to the print servers 1 other than it and shared as the initial settings for the prohibition setting 200.

### (Step S101)

Then, the processing management unit 110 performs a processing request process.

The processing management unit 110 associates the generated job 210 with the prohibition settings 200 and the job ticket 220 and sends them to the other print server to request processing.

According to FIG. 7, the processing management unit 110 sends the job 210, the prohibition setting 200, and the job ticket 220 to the other print server. At this time, a command for above-mentioned restriction may also be added according to the prohibition setting 200.

Further, the processing management unit 110 may encrypt the job 210, and the like, at the time of transferring and sending it to the other print server 1.

### (Step S201)

Then, the process at the other print server is described.

Here, the processing management unit 110 of the other print server performs the job storage process.

The processing management unit 110 receives the job 210, prohibition setting 200, and the job ticket 220 requested for processing from the originating print server and stores them in the storage unit 19. Here, the other print server at the distributed destination stores them in isolation from the others. Thus, the processing management unit 110 can set a plurality of print processing areas 190 in advance, and store the processing-requested job 210, the prohibition setting 200, and the job ticket 220 in the “free” print processing area 190 where the internal data has been erased. In this way, the processing management unit 110 stores the processing-requested job 210, the prohibition settings 200, and the job ticket 220 in a print processing area 190 different from the spool area of the own apparatus. Here, temporary data, or the like, for print processing such as RIP processing corresponding to this stored job 210 may also be configured to be stored in the same print processing area 190.

In the above-mentioned example in FIG. 5, the processing management unit 110 stores the job 210-2, the prohibition settings 200-2, and the job ticket 220-2 in the print processing area 190b (for a request). Thus, the requested job 210 is to be stored in isolation at the distributed site.

Note that if there is no “free” print processing area 190, the processing management unit 110 may store the job 210, prohibition settings 200, and job ticket 220 in another temporary area. Alternatively, the processing management unit 110 may reply to the originating print server of the requesting origin that it cannot receive the job 210, or the like, so that it is not performed in a distributed processing.

### (Step S202)

Then, the prohibition management unit 100 performs the printing condition setting process.

The prohibition management unit 100 refers to the print condition 300 of the prohibition setting 200 and restricts the print attributes that can be specified by the user. In this case, it is possible to restrict the print attributes that can be specified on the UI when accessing other print servers from the management apparatus 6 or other terminals.

Specifically, the prohibition management unit 100 can restrict, for example, function and an attribute that can be performed as restrictions on a print attribute. More specifically, the prohibition management unit 100 can limit the selectable discharge destination to a stacker cart, and the like. This makes it possible to prevent wrong delivery of output printed matters.

Alternatively, the prohibition management unit 100 can limit the number of copies that can be specified to be printed. This can prevent situations such as printing more copies than necessary and having to waste unnecessary copies. It is also possible to prevent discarded printed matter from being leaked.

### (Step S203)

Next, the prohibition management unit 100 determines whether it is on start condition for printing or not.

The prohibition management unit 100 refers to the start condition 310 of the stored prohibition settings 200 and determines Yes if it becomes the set condition. In the above example, if the condition to start print processing after the job 210 is deleted is set, the prohibition management unit 100 checks whether files and data of other jobs 210 are present in the isolated print processing area 190 or in the storage unit 19, and if they are not present in whichever is set, then Yes can be determined. Alternatively, if the condition for removal of printed matters from the discharge destination has been set in the start condition 310, the prohibition management unit 100 can acquire information from a sensor of the component apparatus at the discharge destination. The prohibition management unit 100 checks the number of detected printed matters at the discharge destination, and if this is zero, determine Yes as the other printed matters have been removed. The prohibition control unit 100 otherwise determines No.

If Yes, the prohibition management unit 100 advances the process to step S204.

If No, the prohibition management unit 100 advances the process to step S205.

### (Step S204)

If the condition is to start printing, the processing management unit 110 performs the printing start process.

The processing management unit 110 prints and processes the job 210 for distributed processing, which is stored in the isolated print processing area 190, in accordance with the job ticket 220.

Here, as described above, it is possible to prevent mixing with the other job by starting printing according to the condition that the printing process is started after the other job is deleted.

Alternatively, it is possible to prevent mixed with the other printed matters by starting printing according to the condition that the printed matter of the other job that is output is removed from the discharge destination to start the printing process.

### (Step S205)

Here, the prohibition management unit 100 determines whether it is on the termination condition for printing or not.

The prohibition management unit 100 refers to the termination condition 320 of the stored prohibition setting 200 after the output of the job 210 is completed, and it determines Yes if it becomes the set condition. In the above example, when the condition is set to terminate the printing process after the job 210 is deleted, the prohibition management unit 100 checks the storage unit 19. The prohibition management unit 100 can determine Yes if it is on the condition that the files and data of the job 210 are deleted from the print processing area 190, and the print processing area 190 is deleted. Alternatively, when the condition is set to remove the printed matters from the discharge destination is set in the termination condition 320, the prohibition management unit 100 acquires information from the sensor of the component apparatus at the discharge destination and checks the number of detected printed matters at the discharge destination. If this is zero, the prohibition management unit 100 may determine Yes as the printed matter of the output job 210 has been removed. Otherwise, the prohibition management unit 100 determines No.

If Yes, the prohibition management unit 100 advances the process to step S206.

If No, the prohibition management unit 100 advances the process to step S207.

### (Step S206)

If it is on the termination condition for printing, the processing management unit 110 performs a printing termination process.

The processing management unit 110 may terminate the execution of the job 210 for distributed processing stored in the isolated print processing area 190 and delete the print processing area 190. In other words, the processing management unit 110 may delete the output completed job 210, the prohibition settings 200, and the job ticket 220 from the print processing area 190.

Thus, by completing the printing process after the job 210 is deleted, it is possible to prevent the print data of job 210 from remaining in storage unit 19.

Further, the print process can be completed after the printed matter has been removed from the discharge destination, thereby preventing the printed matter from being left unattended.

Furthermore, before and after this process, the processing management unit 110 sends a processing status notice and a completion notice for the job 210 from the other print server to the originating print server as a result of the process.

Then, the processing management unit 110 of the originating print server acquires the status of the processing according to the prohibition setting 200 from the other print server 1 as the processing status notice.

Again, with referring to FIG. 7, as processed in this way, between the print server 1a in the print line A, which is the originating print server, and the print server 1b in the print line B or the print server 1c in the print line C, which is the other print server, the prohibition setting 200, the job 210, and the job ticket 220 can be delivered and the order can be processed.

Moreover, the prohibition management unit 100 in the originating print server may store the determination of the condition by the prohibition setting 200, whether the processing has done or not, its result of the processing, or the like, in the storage unit 19 as historical information. Here, the prohibition management unit 100 can also set in the history information the number of times of the determination of the condition specified by the prohibition, the waiting time, or the like. Furthermore, the prohibition management unit 100 in the originating print server may set and update the initial settings of the prohibition setting 200 according to the results of this process.

In addition, the processing management unit 110 in the originating print server can also adjust the processing request based on the processing result and the status of the schedule information.

With the above, the distributed prohibition printing process is completed according to the present embodiment.

As configured in this way, the following effects can be achieved.

In typical production printing, distributed print processing among a plurality of printing apparatuses for the purpose of efficiently processing large numbers of print jobs is performed.

When printing secure data in such a distributed manner, it is necessary that the distributed destination printers prints at the security level expected by the requesting side of the print process.

However, there is a possibility of a security incident such as data leakage due to human error by as incorrect operation, or the like.

On the other hand, the industrial printing system X is an industrial printing system for production printing having a plurality of print servers 1 for distributed processing of a job 210, each of the plurality of print servers 1 includes: a prohibition management unit 100 that generates a prohibition setting 200 that restricts printing and processing on other print server in distributed destination for each setting of the job 210; a processing management unit 110 that sends the job 210 associated with the prohibition setting 200 generated by the prohibition management unit 100 to other print server and requests processing.

This configuration allows the requesting source to specify restrictions on printing and processing in units of the job 210 in peer-to-peer type distributed processing. This enables a peer-to-peer industrial printing system that can perform secure output management by restricting operations and processing, and prevent data leakage due to human error, or the like. As a result, security incidents due to human error at distributed destination can be prevented.

Also, in typical production printing, a management server is essential, and it is not always possible to have distributed processing between printing lines (sites).

In contrast, in the industrial printing system X according to the present embodiment, it can provide a peer-to-peer type industrial printing system that does not require a management server. Thus, between the print servers 1, it can flexibly perform distributed processing, and security can be enhanced.

Furthermore, in the industrial printing system X according to the present embodiment, it can be configured as each print server 1 by simply storing the prohibition setting 200 in an already existing print server and installing a dedicated application, or the like. Thus, the print servers 1 can then be linked peer-to-peer.

This makes it possible to easily achieve secure production printing by linking sites that are existing companies, or the like.

Further, in the industrial printing system X according to the present embodiment, the prohibition setting 200 is set a printing condition 300 of the job 210, a start condition 310, and a termination condition 320 of the processing, and the prohibited management unit 100 sets the prohibition setting 200 to prevent mixing with other jobs.

This configuration enables to set the prohibition condition for the function of printing, the start of the printing process, and the termination of the printing process. This allows a prohibition condition to be set in accordance with the characteristics of the printing line and the user intention, thereby security can be improved, reliably.

Further, in the industrial printing system X according to the present embodiment, the printing condition 300 includes a setting that limit the print attributes that can be specified by the user.

This configuration makes it possible to restrict user operations and the processing of job 210. This allows for increased security.

Further, in the industrial printing system X according to the present embodiment, the start condition 310 and the termination condition 320 includes a condition for the removal of the printed matter from the discharge destination.

This configuration reduces security risks due to mixing with the execution of other job and also prevents information leaks, or the like, due to mixing with other printed matters. This allows for increased security.

Further, in the industrial printing system X according to the present embodiment, a processing management unit 110 in the other print server stores the job 210 requested for processing in the print processing area 190, which is isolated.

This configuration reduces the security risk of the spooled job 210 being viewed by others unrelated to the requesting side of the job 210. Thus, security can be enhanced.

### Other Embodiments

In the above-described embodiment, an example in which prohibition setting 200 of a plurality of print servers 1 are set by the originating print server is explained.

However, it may be configured to restrict printing and processing according to the condition of the prohibition setting 200, which has already been stored and set in the storage unit 19 by the other print server. In addition, the prohibition setting 200 may be set for each job 210 by the other print server. In this case, the component apparatus, a GUI setting, or the like, may be changed in the other print server in response to this set prohibition setting 200. Alternatively, the other print server may acquire only the initial setting from the originating print server and determine the condition from the processing requirements of the job 210 and the prohibition setting 200 stored in its own storage unit 19.

With this configuration, it is possible to save time and effort in setting the prohibition setting 200. Also, the condition can be determined by the other print server without acquiring the prohibition setting 200. Thus, security can be enhanced by the prohibition rule without having to set it separately on the originating print server.

In the above-described embodiment, an example of setting prohibition setting 200 after the acquisition of the job 210 is explained.

However, the originating print server may be configured to set the prohibition setting 200 and acquire only the job 210 that can adopt to the prohibition setting 200. Specifically, for example, if the prohibition setting 200 is set, the originating print server may acquire only the job 210 with a security level that is compatible with the prohibition setting 200.

In addition, the system can be configured to select the other print servers to be distributed according to the corresponding prohibition setting 200. In other words, if the prohibition setting 200 is set, the print server 1 or component apparatuses of the printing line that do not be adoptive may not be selected. For example, the originating print server may not select as the other print server for a print server 1 that cannot set the prohibition setting 200, cannot restrict print attribute, cannot support the printing condition 300 or the termination condition 320, or the like. More specifically, a print server 1 that cannot restrict the GUI, cannot choose the discharge destination, cannot acquire the value of the sensor at the discharge destination, or cannot isolate the print processing area 190 may not be selected according to the setting of the prohibition setting 200.

This configuration can increase security more reliably.

In the above-described embodiment, an example in which the initial setting of the prohibition setting 200 is fixed is explained.

However, the initial setting of the prohibition setting 200 may be changed by statistics, AI (Artificial Intelligence), heuristics, rule-based, or the like, based on user settings and historical information. In such case, for example, the prohibition management unit 100 may use the prohibition setting 200 set by the user for a particular printing line as the next initial setting. The prohibition management unit 100 can also set the initial setting for higher or lower security level depending on the result of the condition determination in the historical information.

This configuration allows for a more appropriate setting of the prohibition setting 200.

In the above-described embodiment, an example of determining the other print server from the originating print server without distinguishing between rasterization processing, print processing, and post-processing of the job 210 is described.

However, the print servers 1 (group) to be determined may be differentiated for the printing process and the post-processing process.

In addition, priorities may be set for which apparatuses are to be processed in rasterization processing, print processing, and post-processing. This priority may be set based on the prohibition setting 200, availability of schedule information, number and performance of component apparatuses, cost, and other information.

This configuration allows for more efficient distributed processing of the job 210 to each site.

In the above-described embodiment, an example in which the job 210 is requested to be processed directly to the other print server 1 is explained.

However, the job 210 itself can be modified according to the prohibition settings 200, historical information, a status and completion notification, and an error notification.

In this case, as to be a processable job 210, for example, contacting to the printing line manager to release the condition of the prohibition setting 200 and allowing the job to be printed may be achieved.

Alternatively, the job 210 itself can be split to non-prohibit part and prohibit part for the prohibition setting 200 and the each of the split parts of the job 210 can be sent to the originating print server or to the other print server 1 than the one that requested it.

This configuration makes it possible to execute the job 210 through distributed processing even if a trouble, or the like, occurs.

Further, in the above-mentioned embodiment, an example of distributed peer-to-peer processing is described.

However, each of the processes in the present embodiment can also be applied in a configuration that uses a management server.

Also, it is understood that the configuration and operation of the above-mentioned embodiments are examples, and it may be modified and implemented as appropriate without departing from the intent of the disclosure.

Further, in terms used herein, the singular forms “a,” “an,” and “the” also include the plural forms unless the context clearly indicates otherwise.

What is claimed is:

1. An industrial printing system for performing production printing having a plurality of print servers for distributed processing of a job, each of the plurality of print servers comprising:
a prohibition management unit configured to generate a prohibition setting that restrict printing and processing on other print server in distributed destination for each job setting;
a processing management unit configured to send the job associated with the prohibition setting generated by the prohibition management unit to the other print server and requests processing.

2. The industrial printing system according to claim 1, wherein
the prohibition setting is set a printing condition of the job, a start condition of the process, and a termination condition of the process, and
the prohibition management unit sets the prohibition settings to prevent mixing with other jobs.

3. The industrial printing system according to claim 2, wherein
the printing condition includes a setting that limits the print attribute that allows to be specified by a user.

4. The industrial printing system according to claim 2, wherein
the start condition and the termination condition include a condition for removal of printed matter from the discharge destination.

5. The industrial printing system according to claim 1, wherein
the processing management unit of the other print server stores the job requested for processing in an isolated print processing area.

6. A print server that performs distributed processing of a job in an industrial printing system that performs production printing, comprising:
a prohibition management unit configured to generate a prohibition setting that restrict printing and processing on other print server in distributed destination for each job setting; and
a processing management unit configured to send the job associated with the prohibition setting generated by the prohibition management unit to the other print server and requests processing.

7. The print server according to claim 6, wherein
the prohibition setting is set a printing condition of the job, a start condition of the process, and a termination condition of the process, and
the prohibition management unit sets the prohibition settings to prevent mixing with other jobs.

8. The print server according to claim 7, wherein
the printing condition includes a setting that limits the print attribute that allows to be specified by a user.

9. The print server according to claim 7, wherein
the start condition and the termination condition include a condition for removal of printed matter from the discharge destination.

10. The print server according to claim 6, wherein
the processing management unit of the other print server stores the job requested for processing in an isolated print processing area.

11. A processing management method executed by an industrial printing system having a plurality of print servers that perform distributed processing of a job and performs production printing, comprising the steps of:
generating a prohibition setting that restrict printing and processing on other print server in distributed destination for each job setting; and
sending the job associated with the prohibition setting that is generated to the other print server to request processing.

12. The processing management method according to claim 11, wherein
the prohibition setting is set a printing condition of the job, a start condition of the process, and a termination condition of the process, and further comprising a step of:
setting the prohibition settings to prevent mixing with other jobs.

13. The processing management method according to claim 12, wherein
the printing condition includes a setting that limits the print attribute that allows to be specified by a user.

14. The processing management method according to claim 12, wherein
the start condition and the termination condition include a condition for removal of printed matter from the discharge destination.

15. The processing management method according to claim 11, further comprising a step of:
On the other print server, storing the job requested for processing in an isolated print processing area.
